(19) United States
(12) Patent Application Publication
(10) Pub. No.: US 2011/0140412 A1
(43) Pub. Date: Jun. 16, 2011

(54) SUPPORT STAND FOR PRESSURE VESSEL

(75) Inventors: Roger Manser, Uxbridge, MA (US); Christopher A. VanHaaren, Warwick, RI (US)

(73) Assignee: AMTROL LICENSING INC., West Warwick, RI (US)

(21) Appl. No.: 12/991,507

(22) PCT Filed: May 8, 2009
(86) PCT No.: PCT/US2009/043375

§ 371 Date: Feb. 17, 2011

Related U.S. Application Data
(60) Provisional application No. 61/051,646, filed on May 8, 2008.

(51) Int. Cl. F16L 5/00; F16M 13/00

(52) U.S. Cl. 285/192; 248/346.5

(57) ABSTRACT

A stand for supporting a pressure vessel includes a body having an upper wall and a sidewall extending downwardly from the upper wall, an aperture defined in the upper wall configured to permit passage therethrough of a fluid conduit, the fluid conduit being in fluid communication with the pressure vessel, and a locking element provided in connection with the body configured to engage the fluid conduit when in a locked position to inhibit removal of the stand from the pressure vessel.

### CROSS-REFERENCE TO RELATED APPLICATIONS

This application claims the benefit of priority to U.S. provisional patent application Ser. No. 61/051,646, filed May 8, 2008, which application is incorporated herein by reference, in its entirety.

### FIELD OF INVENTION

The present invention is directed to an improved support stand for a pressure vessel and a method of attaching the stand to the pressure vessel.

### DESCRIPTION OF RELATED ART

There are a variety of devices and methods to attach a stand to a pressure vessel. Typically, particularly with relatively small vessels, stands are formed from steel and are integrally formed with the vessel, such as by welding, for example.

Such conventional methods and systems generally have been considered satisfactory for their intended purpose. However, applicants recognize that steel stands can corrode, resulting in an unsightly appearance, in severe cases compromising the structural and/or functional integrity of the pressure vessel and/or the attached system. Moreover, steel stands can provide problems if electrical isolation of a pressure vessel is desired, as the conductivity of a steel stand could compromise such electrical isolation under certain conditions. Accordingly, Applicants' stand is preferably formed of a nonmetallic material, although the invention is not limited solely to use of such materials, as it will be appreciated by the reader.

Advantageously, stands in accordance with the invention can be configured to attach to a pressure vessel even if conduits or other devices such as pipes, valves, tees, elbows or the like are already connected to the vessel.

Further, the subject stands can advantageously be used as an accessory for quickly and easily increasing the elevation of a pressure vessel, should that be desired. Such a use may be necessary in cases where a particular pitch (slope) of a pipe away from or toward a pressure vessel will not be sufficient to provide adequate flow unless the pressure vessel is raised.

As will be appreciated, stands in accordance with the invention provide solutions to these and various other problems in the art.

### SUMMARY

The purpose and advantages of the present invention will be set forth in and apparent from the description that follows. Additional advantages of the invention will be realized and attained by the devices and related methods particularly pointed out in the written description and claims hereof, as well as from the appended drawings.

The invention includes, in one aspect, a stand for supporting a pressure vessel, the stand comprising a body having an upper wall and a sidewall extending downwardly from the upper wall, an aperture defined in the upper wall configured to permit passage therethrough of a fluid conduit, and a locking element provided in connection with the body configured to engage the fluid conduit when in a locked position to inhibit removal of the stand from the pressure vessel. The fluid conduit can be in fluid communication with the pressure vessel. That is—already connected thereto—upon installation with the stand.

The following optional features can be provided in connection with the aspect referenced above or any of the further aspects of the invention discussed below, and may be combined with each other without limitation, unless such features are mutually exclusive.

In accordance with the invention, the aperture of the upper wall can be configured to permit connection of the stand and the pressure vessel when at least one conduit element is provided on the pressure vessel. The aperture can be sized to accommodate an anticipated connection, based on its size, for example. The aperture can be oblong in configuration. The locking element can be adapted to rotatably engage the fluid conduit, and interferingly inhibit movement of the conduit within the aperture.

The locking element can be pivotally connected to the upper wall of the body. The locking element can include at least one catch for maintaining the locking element in a closed position, thereby maintaining the stand in contact with the pressure vessel. The locking element can include one or more stiffening ribs formed therein for improving resistance of the locking element to applied forces. A stop can be provided on the upper wall of the body for releasably engaging a portion of the locking element, maintaining the locking element in an open position.

A plurality of standoffs can be provided about the perimeter of the upper wall of the stand and are configured for abutting an end surface of the pressure vessel.

Resilient spring elements can be provided on the stand for resiliently abutting a surface of the pressure vessel to inhibit relative movement between the pressure vessel and the stand.

The sidewall of the body can be configured with periodic concave recesses for enhancing rigidity of the body.

At least one aperture can be provided in the sidewall of the body, and can be configured to permit a fluid conduit to pass therethrough.

A reinforced region can be provided on the upper wall of the body adjacent the aperture in the upper wall of the body, for strengthening the body against loads applied thereto. The reinforced region can include a plurality of stiffening ribs integrally formed with the upper wall of the body.

An upper portion of the sidewall of the body can include an outer circumferential recess configured for engaging another stand of a pressure vessel. The other stand can be integral with the pressure vessel or separable therefrom. A plurality of standoffs can be provided about the perimeter of the upper wall of the stand and can be configured for abutting an end surface of the pressure vessel. The outer circumferential recess can be formed in the standoffs.

The body can be configured to permit nesting of adjacent stands with one another to minimize occupied space when stored or shipped.

The body can be formed by a molding process. The body can be formed by an injection molding process. The body can be formed of a nonmetallic material. The body can be formed of a nonferrous material. The body can be formed of a plastic material. The body can be formed of a composite material.

The sidewall can be substantially continuous, extending downwardly from a peripheral region of the upper wall.

The upper wall can include a pivot, the locking element engaging the pivot for pivotal movement, thereabout. The pivot can be integrally molded into the upper wall of the stand.

In accordance with another aspect of the invention, a stand for supporting a pressure vessel is provided including a body having an upper wall and a sidewall extending downwardly from the upper wall, wherein the sidewall extends downwardly from a peripheral region of the upper wall, an aperture defined in the upper wall configured to permit passage therethrough of a fluid conduit, the fluid conduit being in fluid communication with the pressure vessel, and a locking element provided in connection with the body configured to engage the fluid conduit when in a locked position to inhibit removal of the stand from the pressure vessel, wherein the locking element is pivotally connected to the upper wall of the body and includes at least one catch for maintaining the locking element in a closed position, thereby maintaining the stand in contact with the pressure vessel.

The stand can be formed from a corrosion-proof material. The stand can be formed from a corrosion-resistant material. The stand can be formed from a material including a polymeric material.

An upper portion of the sidewall of the body can include an outer circumferential recess configured for engaging another stand of a pressure vessel.

In accordance with a further aspect of the invention, a method of supporting a pressure vessel is provided. The method includes the steps of providing a stand having a body having an upper wall and a sidewall extending downwardly from the upper wall, an aperture defined in the upper wall configured to permit passage therethrough of a fluid conduit, the fluid conduit being in fluid communication with the pressure vessel, and a locking element provided in connection with the body configured to engage the fluid conduit when in a locked position to inhibit removal of the stand from the pressure vessel, placing the stand over the conduit of the pressure vessel and into contact with the pressure vessel, and positioning the locking element into a closed position to inhibit removal of the stand from the pressure vessel.

### BRIEF DESCRIPTION OF THE DRAWINGS

The accompanying drawings, which are incorporated in and constitute part of this specification, are included to illustrate and provide a further understanding of devices and methods of the invention. Together with the description, the drawings serve to explain the principles of the invention, wherein:

FIG. 1 is a bottom isometric view illustrating a stand for a pressure vessel in accordance with the invention, placed on a pressure vessel and shown in an unlatched condition;

FIG. 2 is a bottom isometric view illustrating the stand for a pressure vessel of FIG. 1, placed on a pressure vessel and shown in a latched condition;

FIG. 3 is a bottom isometric view illustrating a stand for a pressure vessel of FIG. 1, placed on a pressure vessel and shown in a latched condition, with a fitting removed to better show the configuration of the latched condition;

FIG. 4 is a top isometric view of the stand of FIG. 1;

FIG. 5 is a bottom isometric view of the stand of FIG. 1;

FIG. 6 is a bottom view of the stand of FIG. 1;

FIG. 7 is a top view of the stand of FIG. 1;

FIG. 8 is a side cross-sectional view of the stand of FIG. 1, taken along line 8-8 of FIG. 6;

FIG. 9 is a detail view of region 9 of FIG. 7;

FIG. 10 is a side view of the stand of FIG. 1;

FIG. 11 is a bottom isometric view of a locking element of the stand of FIG. 1;

FIG. 12 is a bottom view of the locking element of FIG. 11;

FIG. 13 is a cross-sectional view of the locking element of FIG. 12, taken along line 13-13 of FIG. 12;

FIG. 14 is a side view of the locking element of FIG. 11;

FIG. 15 is an end view of the locking element of FIG. 11;

FIG. 16 is a top view of the locking element of FIG. 11;

FIG. 17 is a top isometric view of a stand for a pressure vessel in accordance with an alternate embodiment of the invention;

FIG. 18 is a bottom isometric view of the stand of FIG. 17;

FIG. 19 is a top view of the stand of FIG. 17;

FIG. 20 is a bottom view of the stand of FIG. 17;

FIG. 21 is a side view of the stand of FIG. 17;

FIG. 22 is a side cross-sectional view of the stand of FIG. 17, taken along line 22-22 of FIG. 20; and

FIG. 23 is a detail view of region 23 of FIG. 19.

### DETAILED DESCRIPTION

Reference will now be made in detail to the presently preferred embodiments of the invention, examples of which are illustrated in the accompanying drawings.

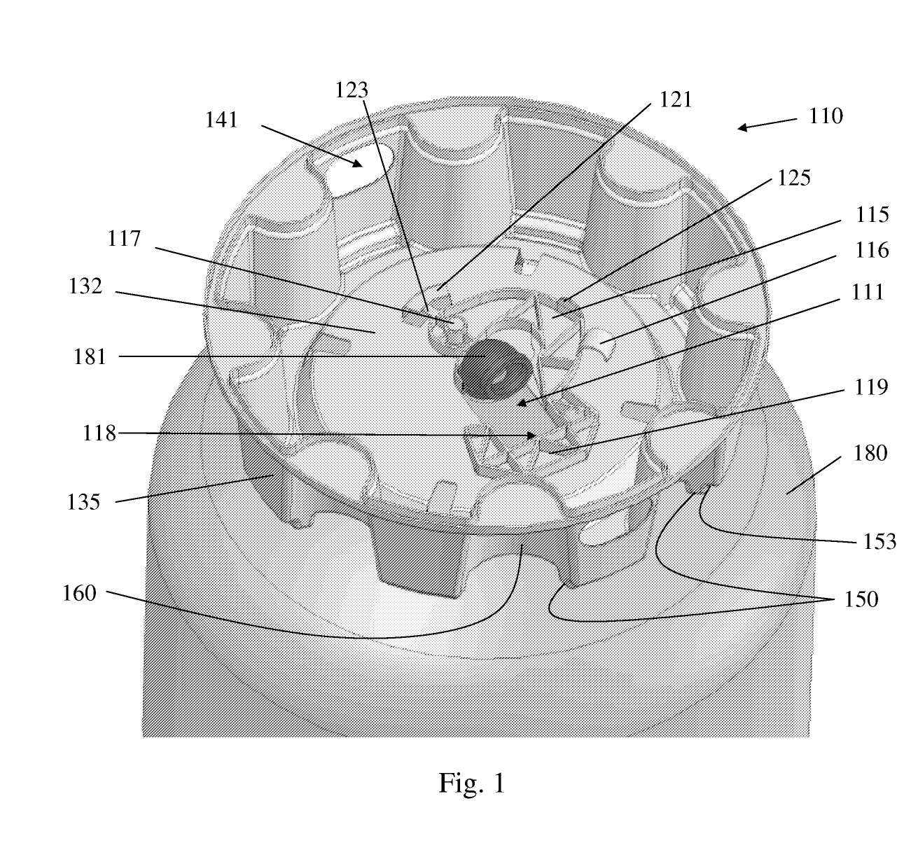

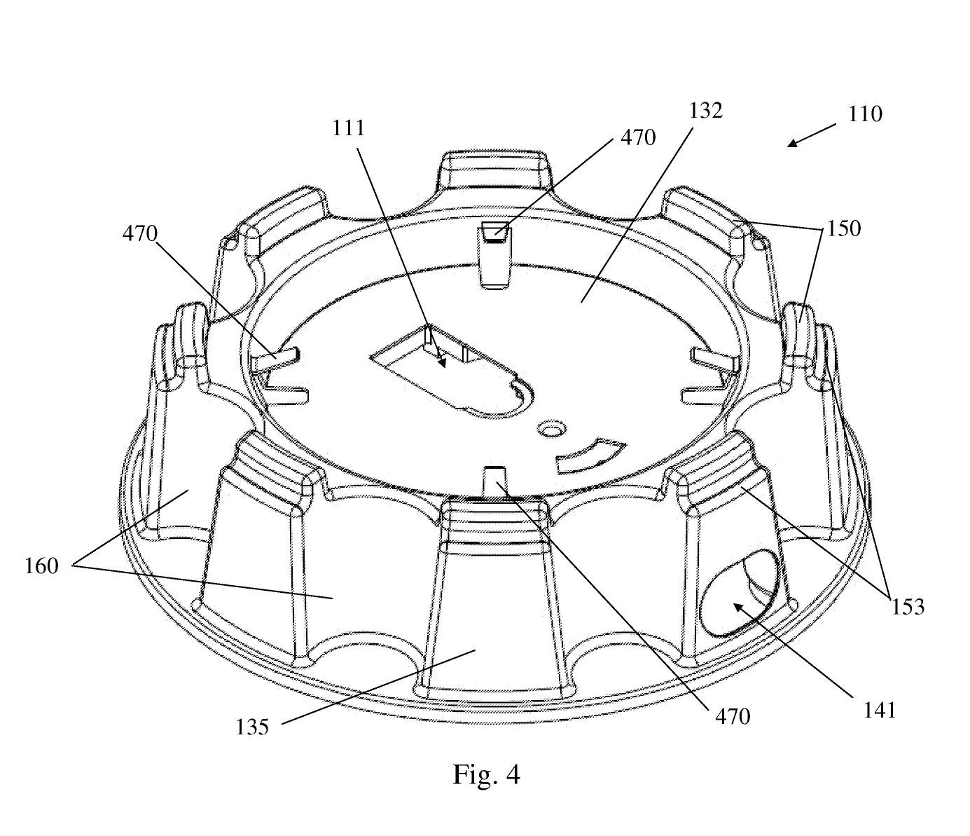

In accordance with one aspect of the invention, and as illustrated for example in FIGS. 1-16, a stand 110 for attachment to and support of a pressure vessel 180 is provided. The stand 110 includes, among other features, a body having an upper wall 132 and a sidewall 135 extending downwardly from the upper wall 132 (with respect to the orientation illustrated in FIG. 4, for example). Stands in accordance with the present invention are preferably formed of a corrosion-resistant material, such as a polymeric or composite material. Materials for forming the stand 110 can include any suitable moldable material, such as polyethylene, polypropylene, fiber-reinforced polymer materials such as glass filled polymer or fiberglass composite materials, and the like.

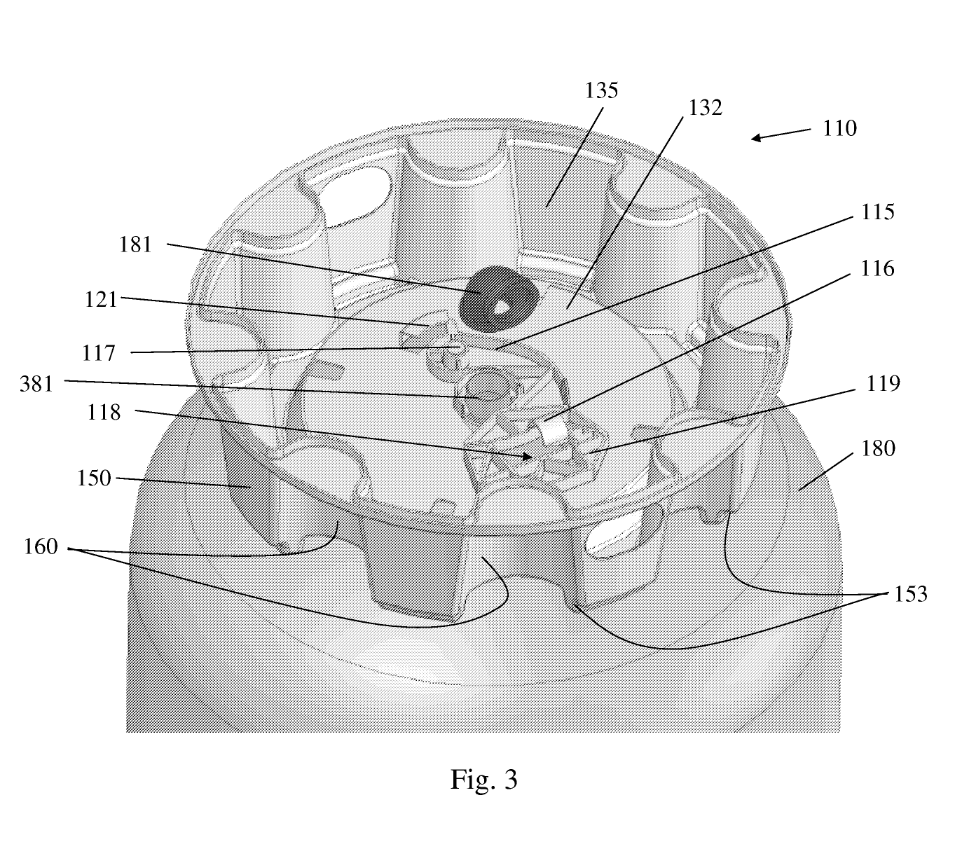

In the illustrated embodiment, an aperture or slot 111 is defined in the upper wall 132, and is configured to permit passage therethrough of a fluid conduit, such as the elbow 181 illustrated in FIGS. 1-3, and/or a system connection or conduit 381 extending from the pressure vessel 180 (See FIG. 3). Each of such conduits, if provided, is in fluid communication with at least one chamber of the pressure vessel 180, and if not integrally formed therewith, is securely attached thereto by a suitable connection, such as threading, soldering or welding, for example. The aperture 111, when the vessel 180 and stand 110 are positioned in the final arrangement, restrains the stand 110 from moving in 3 orthogonal directions in the plane of the stand 110, movement in the fourth direction being inhibited by a locking element 115. The locking element 115 also directly inhibits axial removal of the stand 110 from the pressure vessel 180. As can be seen, one advantage to the present invention is that it allows the stand 110 to be attached to a pressure vessel 180 with a conduit, such as a valve, tee or elbow 181 already installed thereon.

In conjunction with the stand, the locking element 115 fully restrains undesirable movement of the stand 110 with respect to the pressure vessel 180. In accordance with one aspect, the tolerances between the stand 110 and pressure vessel 180 are such that small amounts of expansion and contraction due to temperature changes and/or pressure forces acting on the vessel 180 are permitted.

As best seen in FIGS. 4, 7 and 8, spring elements 470 can be provided on stands 110 in accordance with the invention. Such spring elements 470 advantageously take up any excess axial clearance between the stand 110 and the pressure vessel 180, maintaining contact therebetween, and facilitating stabilization of the pressure vessel 180. The spring elements 470 are compressed during installation of the stand 110 on the vessel 180. The locking element 115 is then rotated into a position, which locks under the conduit (e.g., a tee, pipe or elbow 181), and holds the pressure vessel 180 in position with respect to the stand 110.

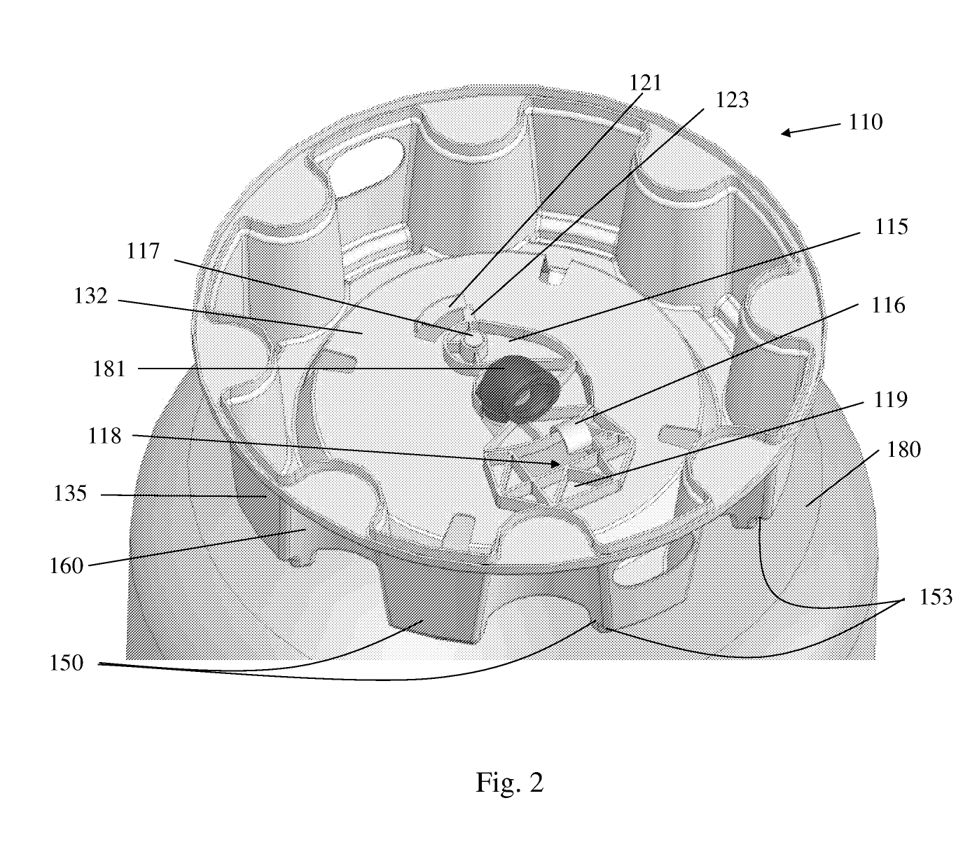

The locking element 115 is provided in connection with the body 110 and configured to engage the fluid conduit, such as vessel system connection 318 or elbow 181, when in a locked position to inhibit removal of the stand 110 from the pressure vessel 180. FIG. 1 illustrates the locking element 115 in an unlocked position, FIG. 2 illustrates the locking element 115 in a locked position, secured around the fluid conduit of the pressure vessel 180, and FIG. 3 illustrates the locking element 115 in a locked position, with the elbow 181 removed to better illustrate the locked configuration of the locking element 115.

The locking element 115 is, in one preferred aspect, pivotally connected to a boss 117 provided in the upper wall 132 of the stand 110. The locking element 115 can alternatively be provided in any suitable manner, and can alternatively be provided as a removable component and/or as a slideable component, for example.

The stand 110 is provided with a reinforced locking region 119, at one end of the aperture 111. The locking region 119 allows for engagement of the locking element 115 when in its locked position. The locking region 119 can be provided with a plurality of stiffening ribs, as illustrated, to improve strength thereof while minimizing material use, and accordingly reducing weight and cost of the stand.

In operation, as illustrated, the locking element 115 is placed over the boss 117, preferably during manufacture and preferably in a manner such that it cannot be easily removed. The locking element 115 is rotated slightly causing a catch 116 on the locking element 115 to be retained by one or more detents 118 provided in the in the locking region 119, which inhibits the locking element 115 from unintentionally rotating out of a locked position, and maintaining the stand 110 in contact with the pressure vessel 180.

As best seen in FIGS. 1-7 and 11-16, the locking element 115 can be provided with various other features. A handle 125 can be provided on the locking element 115 to facilitate gripping by a user. Additionally, a pawl 123 can be provided in the illustrated embodiment, to engage respective portions of a stop 121, provided in connection with the upper wall 132 of the stand 110.

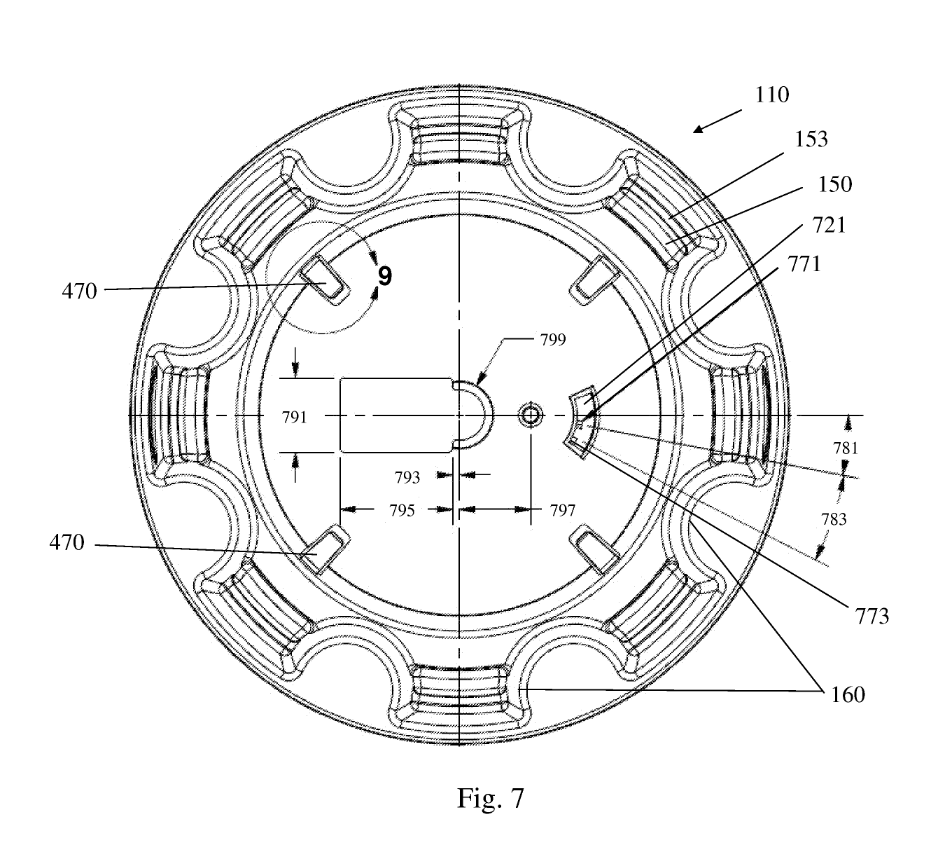

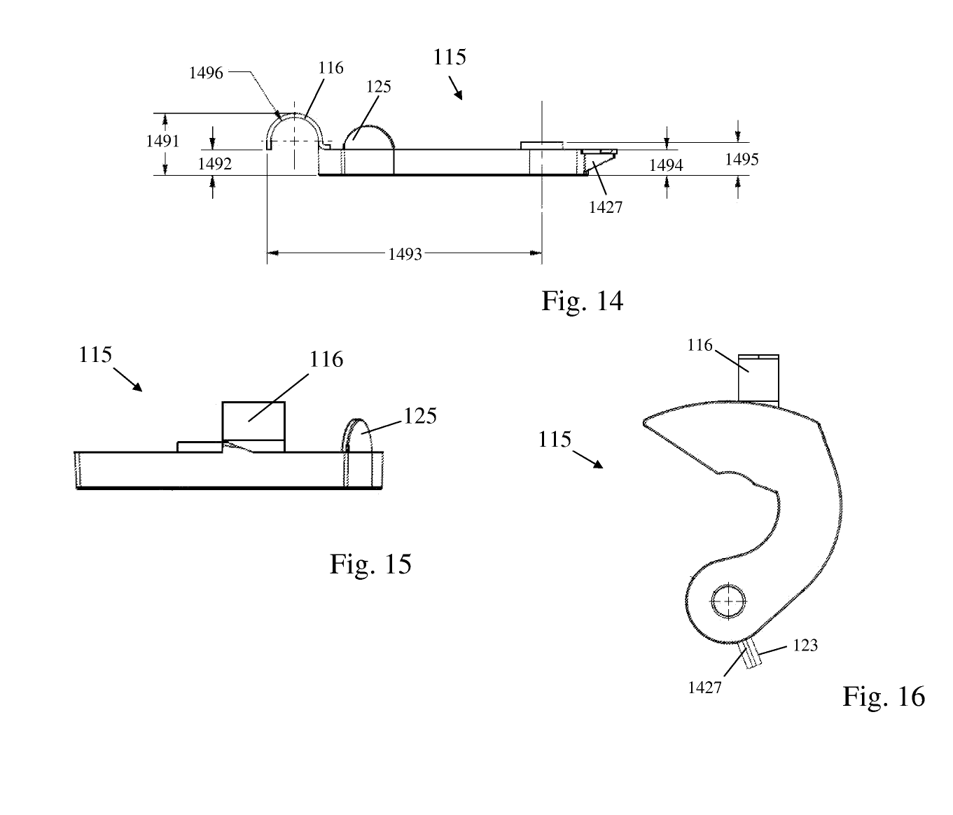

With reference to FIGS. 1-3, 7 and 11-16, the pawl 123 interfaces with the stop 121 to maintain the locking element 115 in either the open position of FIG. 1 or the closed position of FIGS. 2 and 3. The stop 121 is preferably slightly flexible so as to allow passage of the pawl 123 below the stop 121, but allows resilient mutual engagement between the pawl 123 and the stop 121 at the detent 771 (FIG. 7). When engaged with the detent 771, the locking element 115 is maintained in the open position shown in FIG. 1. When the locking element 115 is rotated into the locked position of FIGS. 2 and 3, the catch 116 can be configured to maintain the locking element 115 in the closed position. However, a chamfer 1225 can be provided on the pawl 123 of the locking element 115, and/or a chamfer 773 can be provided on the stop 121 to facilitate initial interface between the pawl 123 and the stop 121 when the locking element 115 is moved from a closed position to an open position. Further, the pawl 123 can be stiffened by a rib 1427 (see FIGS. 14 and 16).

As illustrated, stiffening ribs 1151 can be provided on the locking element to strengthen the locking element 115 while minimizing material use and accordingly, reducing both cost and weight. Similar stiffening ribs can also be provided in the locking region 119.

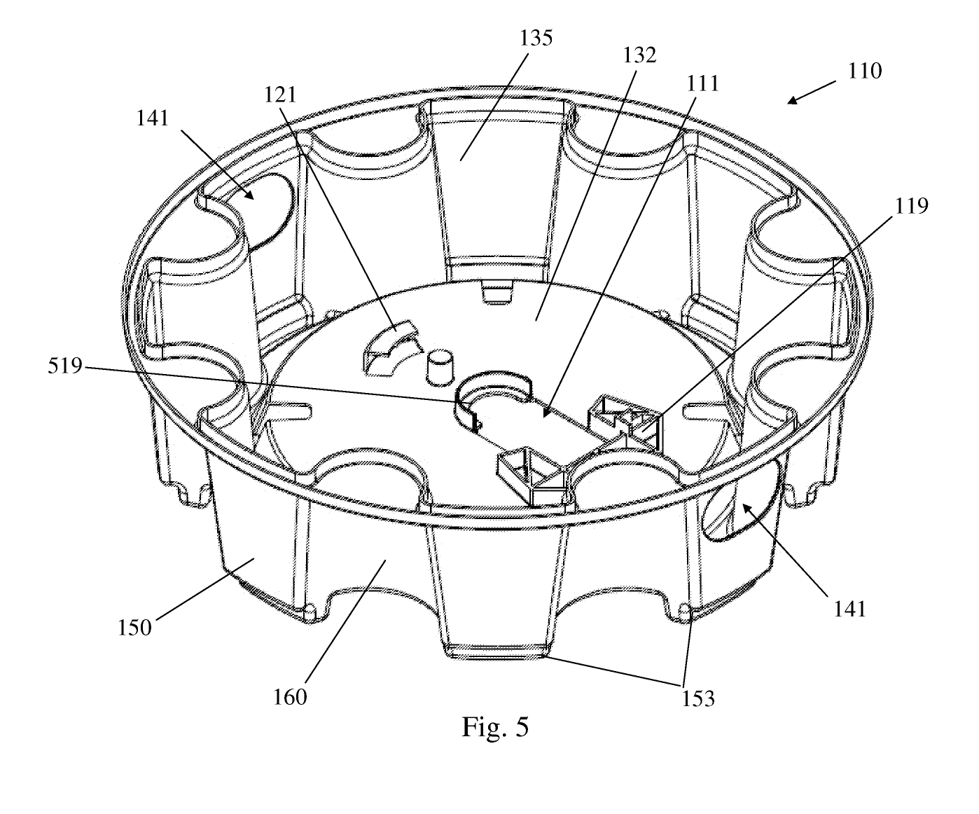

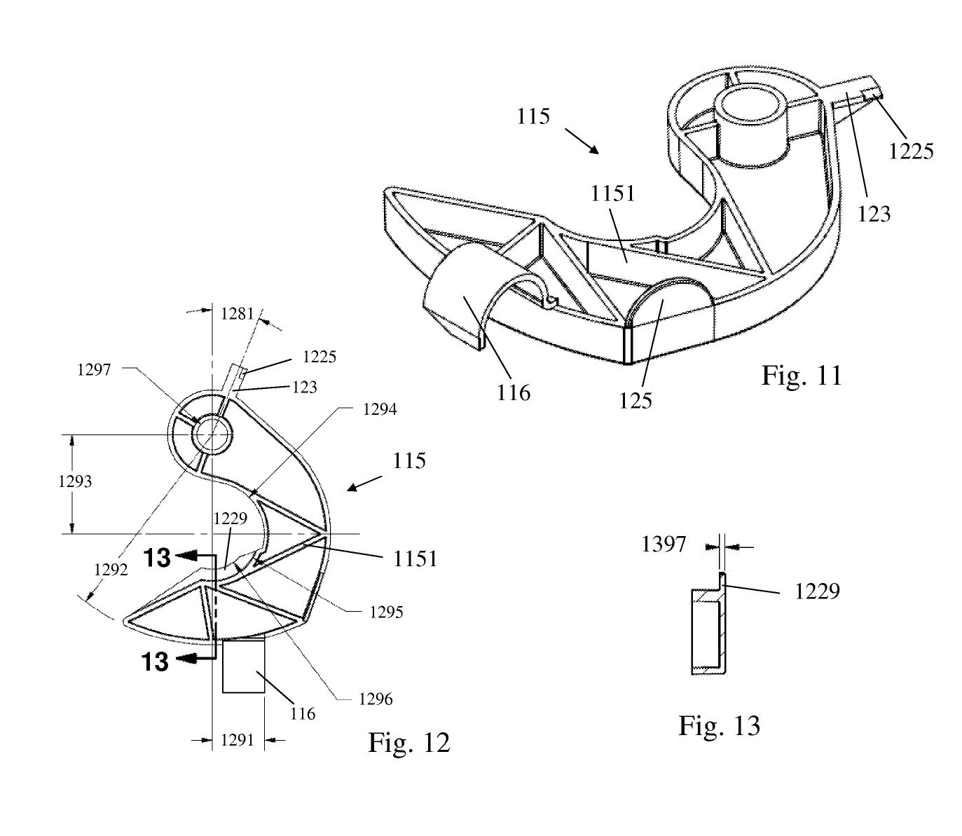

The aperture 111, is illustrated in the embodiment of FIGS. 1-16 as an elongated slot 111, but is not limited to that precise configuration. The configuration of the aperture 111 is preferably such that the stand 110 can be fitted over a pressure vessel 180 when one or more elements, such as elbow 181, are fitted thereto, or provided integrally therewith. As seen in FIG. 5, for example, a flange 519 is provided on an inner portion of the aperture 111, and is configured to engage a connected or integral conduit when in its final secured position. In the illustrated embodiment, the flange 519 sits between the body of the pressure vessel 180 and the elbow 181, and around the system connection 381 of the pressure vessel 180. As will be discussed in more detail below in connection with FIGS. 11-16, the locking element 115 also includes a flange portion 1229 for cooperatively engaging the vessel 180 and attached or integral conduit, in conjunction with the flange 519.

The resulting assembly, including a pressure tank or vessel 180 and other fittings (e.g. elbow 181) is thus securely attached to the stand 110, being held in position as described above. This allows the pressure vessel 180 to be lifted or handled by the stand 110 without concern for the stand 110 separating from the vessel 180, as can sometimes be the case with existing designs. The locking element 115 allows the stand 110 to be easily attached to the pressure vessel 180, but also facilitates simple removal, which is the reverse of installation. As mentioned, the aperture 111 preferably allows the stand 110 to be fitted to a pressure vessel 180 that has a tee, elbow, or length or pipe already installed thereto.

The sidewall 135 of the body of the stand 110 are configured to provide sufficient strength while minimizing material use and weight. The sidewall 135 includes a generally scalloped shape, including periodic arcuate recesses 160. The recesses 160 provide rigidity to the stand 110, resisting application of axial compressive loads, and also provide for increased strength when rolling the pressure vessel 180, such as along a floor. Often such pressure vessels are moved by rolling along one edge of the bottom of the cylinder. Accordingly, stands in accordance with the invention are preferably provided with sufficient strength to withstand such handling.

The sidewall 135 of the stand includes periodic standoffs 150, alternating with the recesses 160. The standoffs 150 are preferably provided with integral shoulders 153 for engaging a lower edge and inner surface of another stand, such as a metal stand as is typically provided integrally with pressure vessels. The periodic arrangement of the standoffs 150 also advantageously helps accommodate a pressure vessel and/or its stand, even if such vessel or stand has a slightly uneven surface. The combination of alternating standoffs 150 and recesses 160 can also advantageously facilitate air circulation below the underside of the pressure vessel 180. Such an arrangement can minimize corrosion of the vessel surface due to condensation or other moisture. Moreover, when stands in accordance with the invention are used in conjunction with an integral metal stand or other metal component, corrosion thereof can be minimized by spacing the metal component from a floor, which can quickly become dirty, damp or wet. Moreover, if used in an unfinished space, such as a dirt-floored crawl space, risk of corrosion is increased.

Stands in accordance with the invention can be provided with one or more apertures 141 in the sidewall 135 thereof, to allow for various system connections to be made to the tank 180. These apertures 141 do not substantially reduce the compressive strength structure of the stand 110 and allow for easy access to the system connection 381 provided on the pressure vessel 180.

Further, in accordance with one aspect of the invention, the stand 110 can be configured such that is nestable with other stands to save space during transport or storage. As can be appreciated by the reader, the stand 110 is preferably formed, such as by molding, with a draft of sufficient magnitude to allow nesting of adjacent stands 110.

If desired, stands in accordance with the invention can be provided with the overall structure illustrated, but without one or more of the vessel engaging features, such as the aperture, springs 470 or ancillary features. If desired, a stand can be provided without an elongated aperture 111, but with an aperture only large enough for a conduit (e.g. system connection 381) to pass therethrough, with connections being made following installation of the stand 110 on the pressure vessel 180. Although such an embodiment would not permit installation over a vessel that already includes conduits attached thereto, other advantageous features of the invention as set forth hereinabove and below are achieved. Moreover, a stand can be provided in accordance with the invention without any aperture, and without springs 470. As described herein, such stand still advantageously be used in conjunction with pressure vessels already having a stand connected thereto or formed integrally therewith. As described herein, the ledge 153 provided in the body of the stand 150 can securely engage the lower portion of a stand of a pressure vessel, such as one currently typically made of metal. Forming a stand in accordance with the invention out of a corrosion-resistant material, such as a plastic material, will still provide benefits to a user, as should be appreciated by the reader.

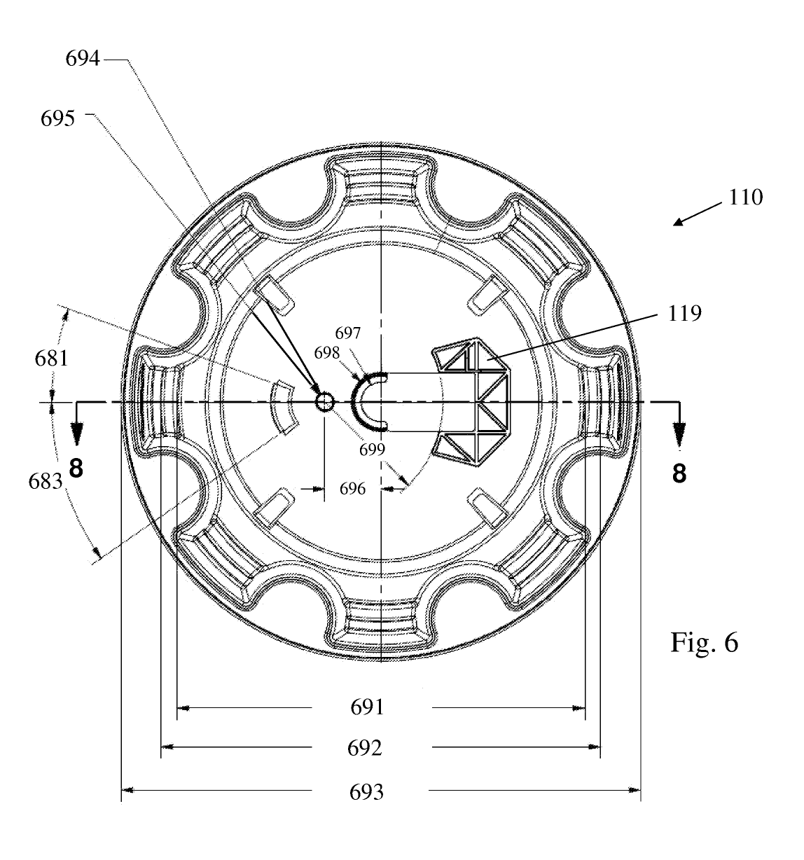

Although the dimensions of stands in accordance with the invention can be selected to suit the unique application for which use thereof is intended, one non-limiting example of dimensions of the stand 110 are illustrated in FIGS. 6-14, and provided below.

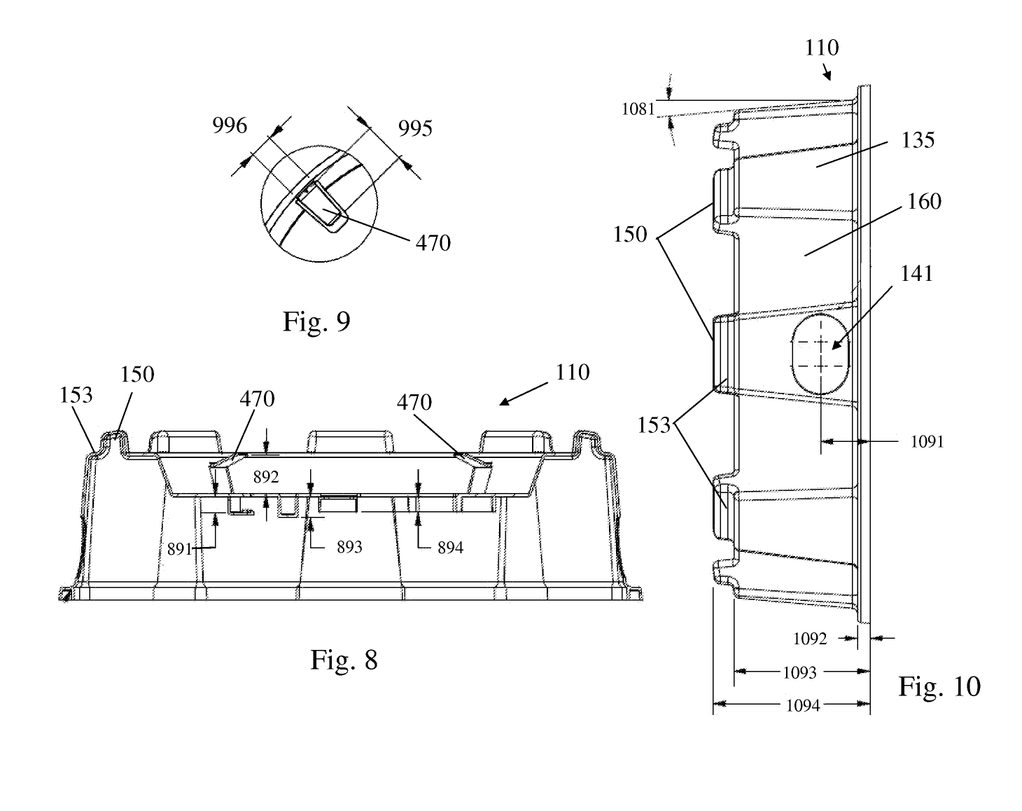

With reference to FIG. 6, in accordance with one embodiment, for the purpose of providing a non-limiting example, distance 691 is about 17.3 inches (439 mm), distance 692 is about 18.7 inches (475 mm) and distance 693 is about 22.0 inches (556 mm), diameter 694 is about 0.75 inches (19 mm) at the bottom of the boss and about 0.72 inches (18 mm) at the top of the boss. In accordance with this embodiment, angle 681 is about 20 degrees, and angle 683 is about 35 degrees. In accordance with this aspect, radius 697 is about 0.84 inches (21 mm), radius 698 is about 1.1 inches (28 mm) and radius 699 is about 5.0 inches (127 mm). With reference to FIG. 7, in accordance with this embodiment, distance 791 is about 2.5 inches (65 mm), distance 793 is about 0.25 inches (6 mm), distance 795 is about 3.8 inches (97 mm), distance 797 is about 2.4 inches (61 mm), radius 799 is about 1.1 inches (28 mm), angle 781 is about 11 degrees and angle 783 is about 16 degrees. With reference to FIG. 8, in accordance with this embodiment, distance 891 is about 0.6 inches (15 mm), distance 892 is about 1.5 inches (38 mm), distance 893 is about 0.8 inches (20 mm), distance 894 is about 0.6 inches (15 mm). With reference to FIG. 9, in accordance with this exemplary embodiment, distance 996 is about 0.75 inches (19 mm) and distance 995 is about 1.5 inches (38 mm). With reference to FIG. 10, in accordance with this exemplary embodiment, distance 1092 is about 0.5 inches (13 mm), distance 1093 is about 5.6 inches (142 mm), distance 1094 is about 6.4 inches (163 mm) and angle 1081 represents about a 5 degree draft of the sidewall 135.

With reference to FIG. 12, in accordance with this exemplary embodiment, distance 1293 is about 2.38 inches (60 mm), radius 1292 is about 5.0 inches (127 mm), distance 1291 is about 1.25 inches (32 mm), radius 1296 is about 0.84 inches (21 mm), radius 1295 is about 1.14 inches (29 mm), radius 1294 is about 1.23 inches (31 mm), angle 1281 is about 22 degrees, and diameter 1297 is about 0.73 inches (19 mm).

With reference to FIG. 13, in accordance with this exemplary embodiment, distance 1397 is about 0.09 inches (2 mm).

With reference to FIG. 14, in accordance with this exemplary embodiment, distance 1491 is about 1.41 inches (36 mm), distance 1492 is about 0.59 inches (15 mm), distance 1493 is about 6.2 inches (157 mm), distance 1494 is about 0.59 inches (15 mm), distance 1495 is about 0.75 inches (19 mm), and radius 1496 is about 0.53 inches (13 mm).

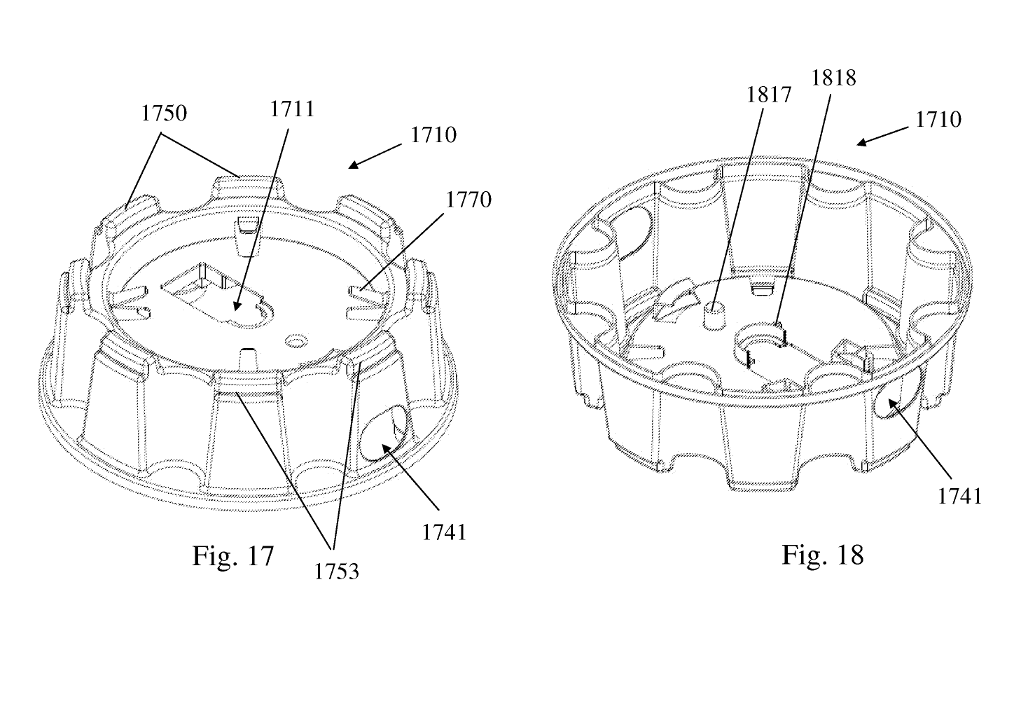

With reference to FIGS. 17-22, an alternate exemplary embodiment of a stand 1710 in accordance with the invention is illustrated. The stand 1710 is in many respects similar to stand 110 of FIGS. 1-16, unless otherwise noted herein. As seen in FIGS. 17 and 18, an aperture 1711, springs 1770, standoffs 1750, ledges 1753, apertures 1741 and a pivot or boss 1817 are provided and function as described above in connection with the stand of FIGS. 1-16.

Additionally, as shown in the embodiment of stand 1710 of FIGS. 17-22, such stands can include a protrusion 1818 provided around the aperture 1711 to maintain the locking element 115 in an open position when the stand 110 is moved into position on the pressure vessel. This allows the stand 110 to be slipped over a conduit or elbow. The locking element 115 can then be rotated to attach the stand 110 to the pressure vessel or tank 180.

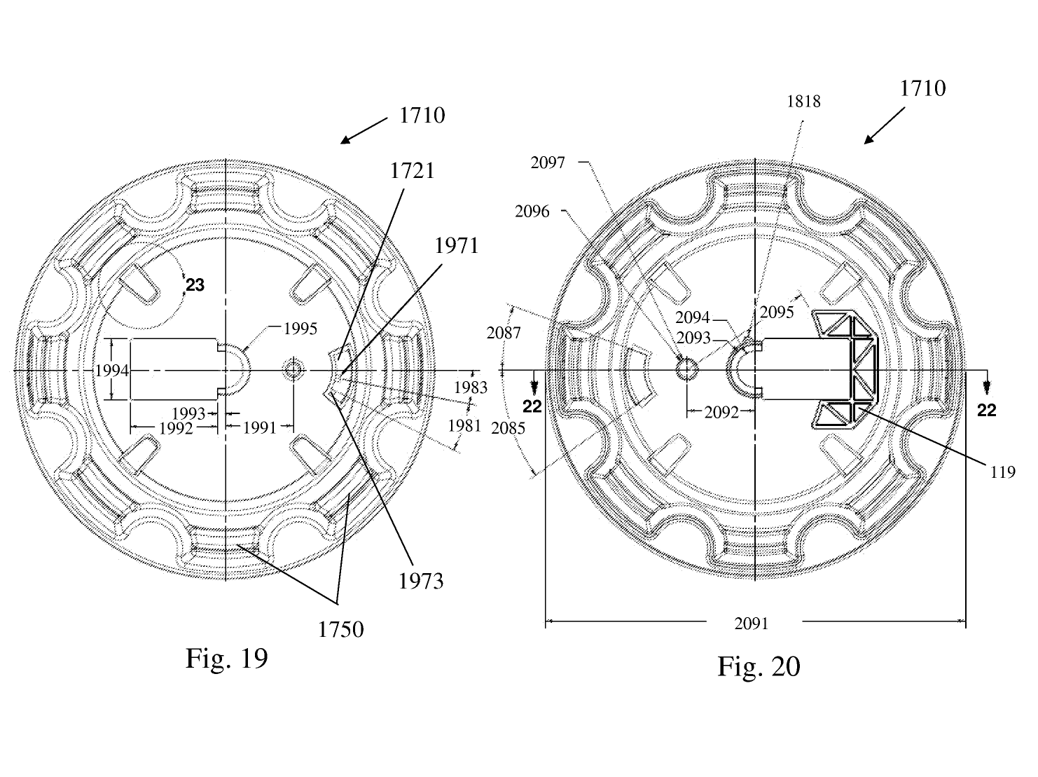

Although the dimensions of stands in accordance with the invention can be selected to suit the unique application for which use thereof is intended, a non-limiting example of dimensions of the stand 1710 are provided in FIGS. 19-21.

With reference to FIG. 19, in accordance with one embodiment, for the purpose of providing a non-limiting example, distance 1992 is about 3.25 inches (83 mm), distance 1993 is about 0.25 inches (6 mm), distance 1991 is about 2.5 inches (64 mm), distance 1994 is about 2.25 inches (57 mm), radius 1995 is about 0.94 inches (24 mm), angle 1981 is about 16 degrees and angle 1983 is about 11 degrees.

With reference to FIG. 20, in accordance with this exemplary embodiment, diameter 2091 is about 15.4 inches (391 mm), distance 2092 is about 2.5 inches (64 mm), radius 2093 is about 0.9 inches (23 mm), radius 2094 is about 0.67 inches (17 mm), radius 2095 is about 5.0 inches (127 mm), diameter 2096 at the top of boss 1817 is about 0.72 inches (18 mm), diameter 2097 at the bottom of the boss is about 0.75 inches (19 mm), diameter 2096 is about 0.72 inches (18 mm), diameter 2097 is about 0.75 inches (19 mm), angle 2087 is about 20 degrees and angle 2085 is about 35 degrees.

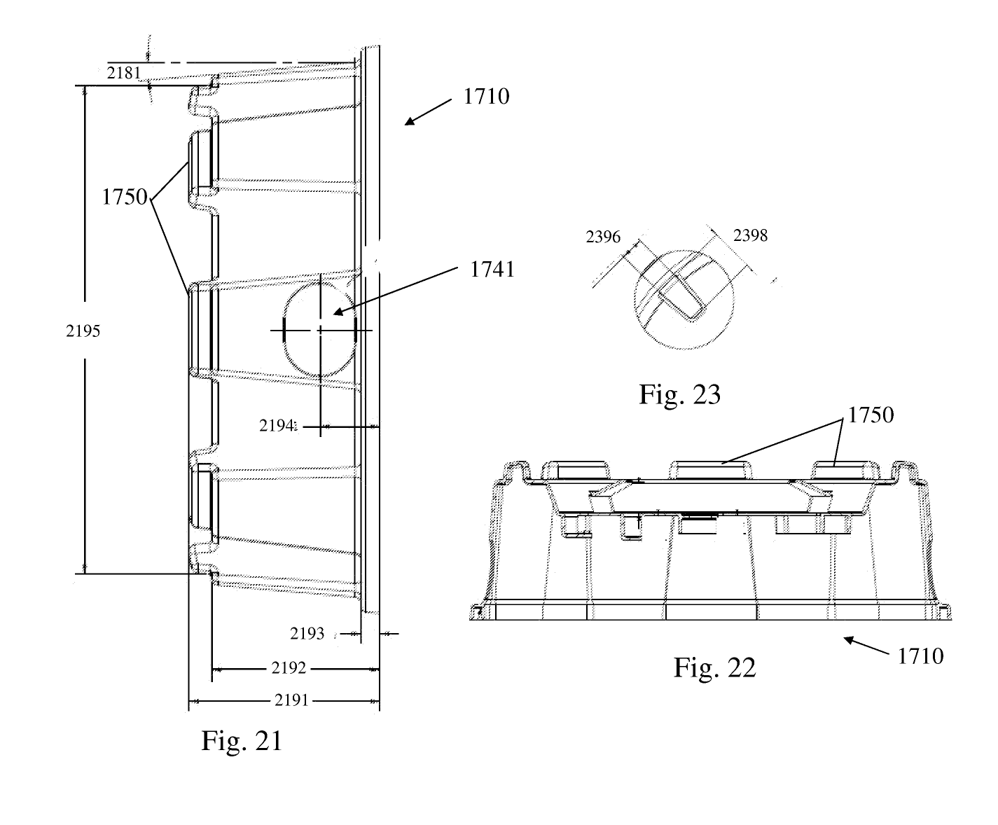

With reference to FIG. 21, in accordance with this exemplary embodiment, distance 2195 is about 13.3 inches (338 mm), distance 2194 is about 1.61 inches (41 mm), distance 2193 is about 0.5 inches (13 mm), distance 2192 is about 4.5 inches (114 mm), distance 2191 is about 5.1 inches (130 mm), and angle 2181 represents a draft of about 5 degrees.

With reference to FIG. 23, in accordance with this exemplary embodiment, distance 2396 is about 0.75 inches (19 mm) and distance 2398 is about 1.5 inches (38 mm).

In accordance with still a further aspect of the invention, tanks in accordance with the invention can be provided with a rotation-locking feature, such as can be effected by a quarter turn twist of the stand with respect to a pressure vessel. In accordance with this aspect, such an arrangement can be accomplished, for example, by providing a small diameter steel ring with tabs welded to a tank or pressure vessel. A corresponding mating ring can then be provided on the stand, such as by molding into the stand. Such mating ring can include tabs molded therein, and can be angled to facilitate close engagement between the stand and the tank. In operation, in accordance with one example, the stand is rotated by a predetermined amount (e.g., 90 degrees), and it is thus drawn against the tank. At the end of its rotation, the ring and stand can be mutually configured such that the stand snaps into place, mutually attaching the stand to the tank.

Although stands for holding a pressure vessel have been described with respect to preferred embodiments, those skilled in the art will readily appreciate that changes and modifications may be made thereto without departing from the spirit and scope of the subject invention. Particularly, it is to be understood that specific aspects of the invention described in connection with one embodiment can additionally be applied to any other embodiment set forth herein, the only limitation to such combination being mutually exclusive features of embodiments.

1. A stand for supporting a pressure vessel, the stand comprising:
a) a body having an upper wall and a sidewall extending downwardly from the upper wall;
b) an aperture defined in the upper wall configured to permit passage therethrough of a fluid conduit; and
c) a locking element provided in connection with the body configured to engage the fluid conduit when in a locked position to inhibit removal of the stand from the pressure vessel.

2. The stand of claim 1, wherein the fluid conduit is in fluid communication with the pressure vessel.

3. The stand of claim 1, wherein the aperture is configured to permit connection of the stand and the pressure vessel when at least one fluid conduit is provided on the pressure vessel.

4-9. (canceled)

10. The stand of claim 1, wherein a plurality of standoffs are provided about the perimeter of the upper wall of the stand and are configured for abutting an end surface of the pressure vessel.

11. The stand of claim 1, wherein resilient spring elements are provided on the stand for resiliently abutting a surface of the pressure vessel to inhibit relative movement between the pressure vessel and the stand.

12. (canceled)

13. The stand of claim 1, wherein at least one aperture is provided in the sidewall of the body, and is configured to permit a fluid conduit to pass therethrough.

14-15. (canceled)

16. The stand of claim 1, wherein an upper portion of the sidewall of the body includes an outer circumferential recess configured for engaging another stand of a pressure vessel.

17-18. (canceled)

19. The stand of claim 1, wherein the body is formed by selecting from the group consisting of a molding process, and an injection molding process.

20. (canceled)

21. The stand of claim 1, wherein the body is formed of a material selected from the group consisting of a nonmetallic material, a nonferrous material, a plastic material, and a composite material.

22-25. (canceled)

26. The stand of claim 1, wherein the upper wall includes a pivot, the locking element engaging the pivot for pivotal movement thereabout.

27. The stand of claim 26, wherein the pivot is integrally molded into the upper wall of the stand.

28. The stand of claim 1, wherein the locking element is pivotally connected to the upper wall of the body and includes at least one catch for maintaining the locking element in a closed position, thereby maintaining the stand in contact with the pressure vessel.

29. The stand of claim 28, wherein the stand is formed of a material selected from the group consisting of a corrosion-proof material, a corrosion-resistant material, and a material including a polymeric material.

30-31. (canceled)

32. The stand of claim 28, wherein an upper portion of the sidewall of the body includes an outer circumferential recess configured for engaging another stand of a pressure vessel.

33. A method of supporting a pressure vessel comprising the steps of:
a) providing a stand having:
i) a body having an upper wall and a sidewall extending downwardly from the upper wall;
ii) an aperture defined in the upper wall configured to permit passage therethrough of a fluid conduit, the fluid conduit being in fluid communication with the pressure vessel; and
iii) a locking element provided in connection with the body configured to engage the fluid conduit when in a locked position to inhibit removal of the stand from the pressure vessel;
b) placing the stand over the conduit of the pressure vessel and into contact with the pressure vessel; and
c) positioning the locking element into a closed position to inhibit removal of the stand from the pressure vessel.
